(19) United States
(12) Patent Application Publication
(10) Pub. No.: US 2017/0322425 A1
(43) Pub. Date: Nov. 9, 2017

(54) Cube, Polarizing Beam-Splitter with Reduced Incident-Angle

(71) Applicant: Moxtek, Inc., Orem, UT (US)

(72) Inventors: Bin Wang, Lindon, UT (US); Hua Li, Lindon, UT (US); Brian Bowers, Kaysville, UT (US)

(21) Appl. No.: 15/460,913

(22) Filed: Mar. 16, 2017

Related U.S. Application Data
(60) Provisional application No. 62/333,610, filed on May 9, 2016.

(51) Int. Cl. G02B 27/28; G03B 21/20; G02B 5/04

(52) U.S. Cl. CPC G02B 27/283; G02B 5/04; G03B 21/2073

(57) ABSTRACT

A cube, polarizing beam-splitter can include an irregular-shaped prism to allow reduced incidence angle on the polarizer, thus resulting in improved optical performance.

### CLAIM OF PRIORITY

This application claims priority to U.S. Provisional Patent Application No. 62/333,610, filed on May 9, 2016, which is incorporated herein by reference in its entirety.

### FIELD OF THE INVENTION

The present application is related generally to optical devices, namely polarizing beam splitters.

### BACKGROUND

A cube polarizing beam splitter (PBS) can be used to split a beam of light into two, oppositely-polarized light beams. The cube PBS can include a polarizer sandwiched between two prisms. See for example US 2007/0297052. Light can enter a face of the cube PBS with an incident angle of 90°, then be polarized with an incident angle of 45° between the polarizer and an optical axis of the beam of light.

Although the optical axis of the beam of light can have a 45° incident angle with the polarizer, light in the light beam can have various angles of incidence on the polarizer because of light divergence. For example, with a 45° incident angle of the optical axis of the beam of light and the polarizer and a +/−16° cone angle of the beam of light, actual incident angles of light in the light beam might range from about 29° through about 61°. Performance of the polarizer can diminish at high incident angles, so there can be a noticeable difference in performance of the light at 29° compared to the light at 61° and both compared to the light at 45°.

The problem of poor performance at higher angles of incidence is worsened if an adhesive is used with a lower index of refraction than that of the prisms. For example, if the prisms have an index of refraction of 1.78 and the adhesive has an index of refraction of 1.647, then actual incident angles of the beam of light, with +/−16° cone angle in the prism, becomes 31.6° through 71.0°, due to refraction of the light as it moves from the high index prism to the lower index adhesive. Polarization of the light at the higher angle of incidence) (71.0°) can especially be difficult.

If the cube PBS is used in an image projector, the quality or resolution of the projected image can suffer due to this variation in performance. It would be beneficial to reduce the angle of incidence of the beam of light on the polarizer, in order to improve performance of the polarizer.

### SUMMARY

It has been recognized that it would be advantageous to reduce the angle of incidence of the beam of light on the polarizer in a cube polarizing beam splitter (PBS). The present invention is directed to various embodiments of cube polarizing beam splitters that satisfy these needs. Each embodiment may satisfy one, some, or all of these needs.

The cube PBS can comprise a first prism including two ends linked by an inner face, a first side, and a second side; a second prism including two ends linked by an inner face, a first side, and a second side; and a polarizer sandwiched between the inner face of the first prism and the inner face of the second prism. A first angle, between a plane of the first side of the first prism and a plane of the inner face of the first prism, can have a value of between 10 degrees and 42.5 degrees.

### BRIEF DESCRIPTION OF THE DRAWINGS (DRAWINGS MIGHT NOT BE DRAWN TO SCALE)

FIG. 1 is a schematic, cross-sectional side-view of a cube polarizing beam splitter (PBS) 10, with a first angle 15 that has a value of between 10 degrees and 42.5 degrees, in accordance with an embodiment of the present invention.

FIG. 2 is a schematic perspective-view of a first prism 14 including two ends 11 linked by an inner face 19, a first side 13, and a second side 12; and a second prism 24 including two ends 21 linked by an inner face 29, a first side 23, and a second side 22, in accordance with an embodiment of the present invention.

FIG. 3 is a schematic, cross-sectional side-view of a cube PBS 30 with an irregular-shaped first prism 14 and a smaller second prism 24, in accordance with an embodiment of the present invention.

FIG. 4 is a schematic perspective-view of the cube PBS 30, in accordance with an embodiment of the present invention.

FIGS. 5-6 are schematic top-views of image projectors 40 and 50, each including a cube PBS 45, in accordance with embodiments of the present invention.

### DEFINITIONS

As used herein, “cube” means an approximately cube-shaped optical device, usually with about six sides. Opposite sides are not necessarily parallel. The sides do not have to have the same area with respect to each other. Examples of cubes are shown in the figures.

As used herein, efficiency means a fraction transmission of a predominantly-transmitted polarization (e.g. Tp) times a fraction reflectance of an opposite polarization (e.g. Rs).

### DETAILED DESCRIPTION

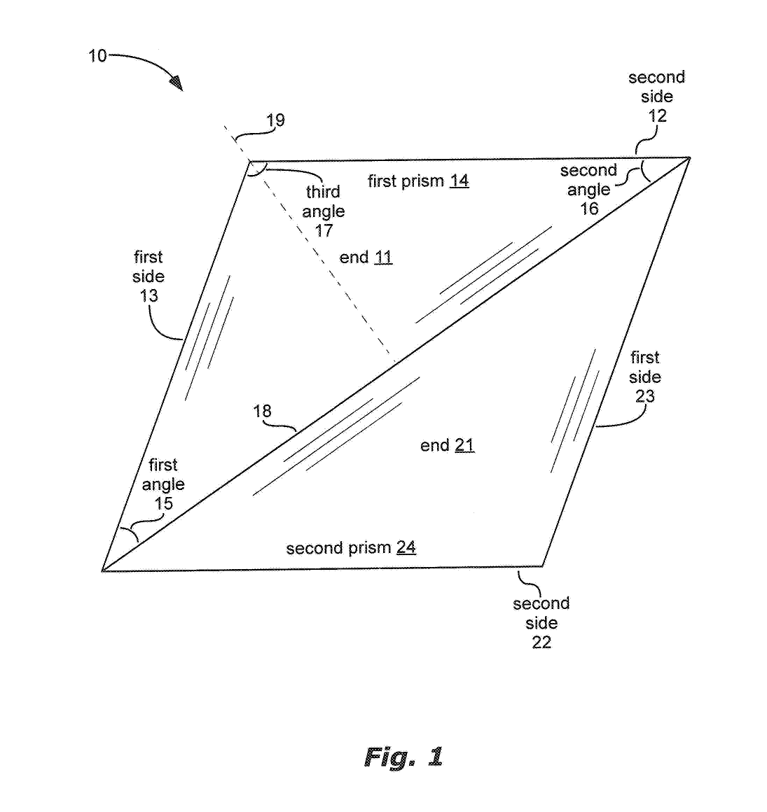

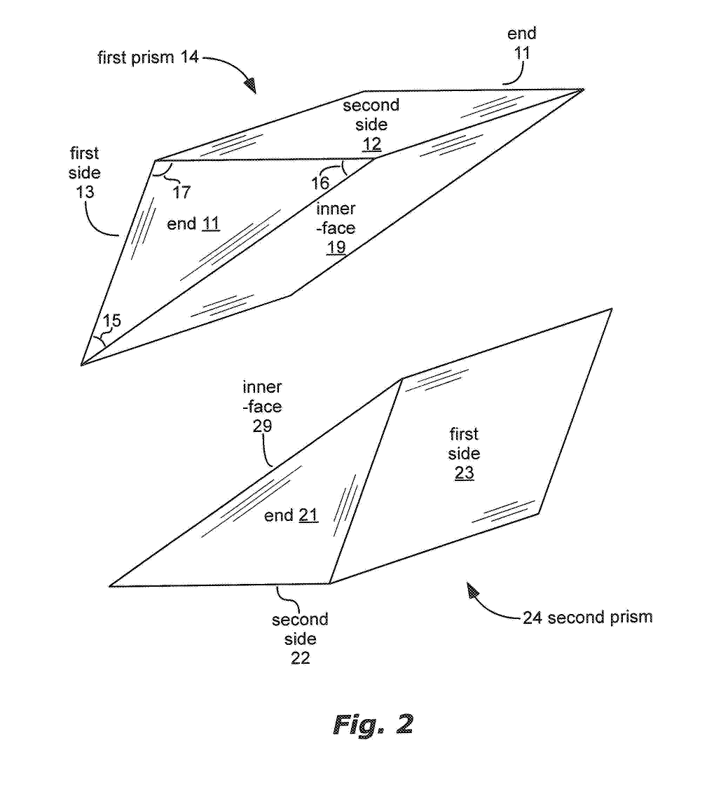

Illustrated in FIGS. 1 & 3 are cube polarizing beam-splitters (PBS) 10 and 30, respectively, each comprising a polarizer 18 sandwiched between a first prism 14 and a second prism 24. The prisms 14 and 24 are displayed separately without the polarizer 18 in FIG. 2. The polarizer 18 can be any suitable polarizer, including a wire grid polarizer or a film polarizer.

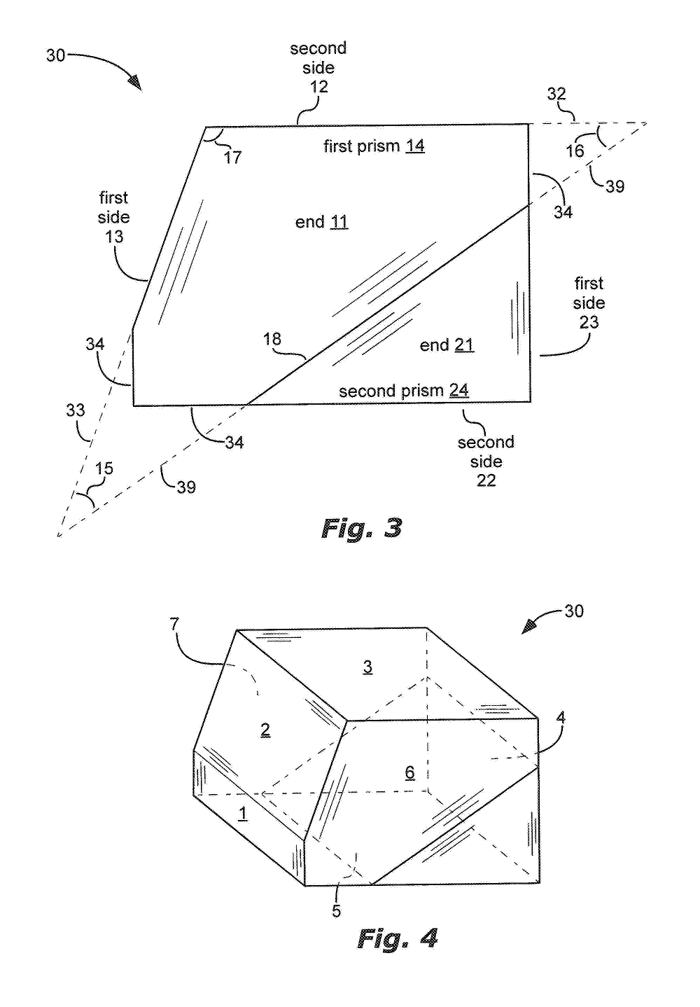

The first prism 14 can include two ends 11 linked by an inner face 19, a first side 13, and a second side 12. A second prism 24 can include two ends 21 linked by an inner face 29, a first side 23, and a second side 22. The ends 11 or 21 can be linked by additional sides, such as for example sides 34 shown in FIG. 3. The polarizer 18 can be sandwiched between the inner face 19 of the first prism 14 and the inner face 29 of the second prism 24.

The first prism 14 can have a first angle 15 between a plane 33 of its first side 13 and a plane 39 of its inner face 19. The first angle 15 can be less than 45 degrees. For example, the first, angle 15 can be less than 42.5 degrees, less than 40 degrees, or less than 35 degrees. The first angle 15 can be greater than 0 degrees. For example, the first angle 15 can be greater than 10 degrees, greater than 15 degrees, greater than 20 degrees, or greater than 25 degrees.

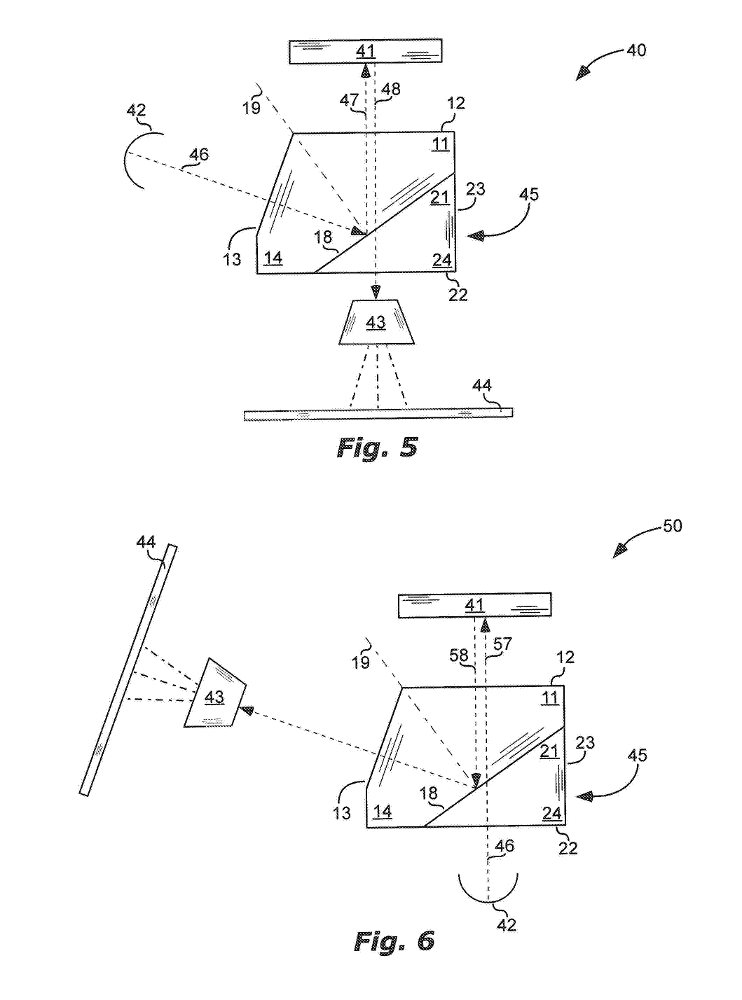

As shown in FIG. 5, a light source 42 can be located to face the first side 13 of the first prism 14, with an optical axis of the incoming beam of light 46 that is perpendicular to this first side 13. Transmitted wavefront distortion of the beam of light 46 as it enters the cube PBS 40 can be minimized by this perpendicular arrangement. Selection of a first angle 15 that is less than 45 degrees can allow a smaller angle of incidence of the incoming beam of light 46 on the polarizer 18.

For example, the first angle 15 can be 35 degrees. The light source 42 can be located to emit a beam of light 46, with an angular-width of +/−16°, and an optical axis perpendicular to the first side 13 of the first prism 14. The optical axis of the beam of light 46 can have a 35 degree angle of incidence on the polarizer 18 (same as the first angle 15). A cone of the beam of light 46 can have angles of incidence ranging from about 19 degrees through about 51 degrees. Variation across the wavefront of this cone of light can be improved compared to a traditional cube PBS with a 45 degree angle of incidence of the optical axis. Performance of light near an outer edge (e.g. 51 degrees) of the beam of light 46 in the present invention can be better than performance of light near an outer edge (e.g. 61 degrees) of a beam of light in a traditional cube PBS.

The present invention is particularly helpful at lower wavelengths of light. Table 1 shows prior-art efficiency across a beam of light, assuming angular-width of the beam to be +/−16°, with an angle of incidence on the polarizer equal to 45°, Table 2 shows efficiency of the present invention across a beam of light, assuming angular-width of the beam to be +/−16°, with the first angle 15 and the angle of incidence on the polarizer 18 equal to 35°.

TABLE 1

| | 29° | 61° | Difference |
|---|---|---|---|
| Efficiency (400 nm) | 0.57 | 0.05 | 0.52 |
| Efficiency (435 nm) | 0.66 | 0.45 | 0.21 |

TABLE 2

| | 19° | 51° | Difference |
|---|---|---|---|
| Efficiency (400 nm) | 0.61 | 0.42 | 0.19 |
| Efficiency (435 nm) | 0.63 | 0.65 | 0.02 |

As shown in the tables, overall efficiency and especially efficiency at larger angles of incidence can be substantially improved with the smaller angle of incidence of the present invention. Also, a difference of efficiency across the beam of light (i.e. across different angles of incidence of the beam of light) can be substantially reduced. Thus, overall performance of the cube PBS and wavefront distortion can be improved by the present invention.

For example, a 435 nanometer wavelength incident light beam, with a 90° angle of incidence on the first side 13 of the first prism 14, an angle of incidence on the polarizer equal to the first angle 15, and an angular-width equal to the angle of incidence +/−16°, can have a high efficiency across the angular-width of the light beam. Examples of the high efficiency include at least 50%, at least 55%, and at least 60%.

As another example, light across wavelength range of 400 through 700 nanometers, with a 90° angle of incidence on the first side 13 of the first prism 14, an angle of incidence on the polarizer equal to the first angle 15, can satisfy the equation |Eff₋₁₆−Eff₊₁₆|<X, where: Eff₋₁₆ is an efficiency of the cube PBS with an angle of incidence on the polarizer equal to the first angle minus 16 degrees and Eff₊₁₆ is an efficiency of the cube PBS with an angle of incidence on the polarizer equal to the first angle plus 16 degrees. Examples of the variable X include 0.2.5 and 0.20.

The first prism 14 can have a second angle 16, between a plane 32 of its second side 12 and a plane 39 of its inner face 19. The second angle 16 can be selected so that light, reflected off of the polarizer 18 (see light beam 47 in FIG. 5) will exit through the second side 12 with an optical axis perpendicular to the second side 12. Distortion in the beam of light 47 as it exits the second side 12 can be minimized by this perpendicular arrangement, which can be accomplished if the second angle 16 is equal to the first angle 15. The second angle 16 can be substantially close to the first angle 15. Thus, for example, a difference between the first angle 15 and the second angle 16 can be less than one degree, less than three degrees, less than five degrees, or less than ten degrees.

Similar to the first angle 15, the second angle 16 can also be less than 45 degrees. For example, the second angle 16 can be less than 42.5 degrees, less than 40 degrees, or less than 35 degrees. The second angle 16 can be greater than 0 degrees. For example, the second angle 16 can be greater than 10 degrees, greater than 15 degrees, greater than 20 degrees, or greater than 25 degrees.

The first prism 14 can have a third angle 17 between a plane 33 of its first side 13 and a plane 32 of its second side 12. The third angle 17 can be important for establishing a relationship between the first side 13 and the second side 12 of the first prism 14. Examples of relationships between the first angle 15, the second angle 16, and the third angle 17 of the first prism 14 include: |180−2*first angle−third angle|<5 degrees and |180−2*second angle−third angle|<5 degrees.

A relationship of the third angle 17 and the polarizer 18 can be quantified by a relationship between a perpendicular-line (a line perpendicular to a face of the polarizer 18) and a bisecting-line (a line that bisects the third angle 17). In a preferred embodiment, the perpendicular-line and the bisecting-line (both shown by line 19 in FIGS. 1, 5, and 6) are perfectly aligned. Substantial alignment of the perpendicular-line and the bisecting-line can be acceptable in some designs. For example: |perpendicular-line−bisecting-line|<1 degree, |perpendicular-line−bisecting-line|<5 degrees, or |perpendicular-line−bisecting-line|<10 degrees.

As shown in FIGS. 1 & 2, a profile (or shape) of the first prism 14 can be the same as a profile (or shape) of the second prism 24. The first prism 14 can have the same dimensions as the second prism 24. Equality or the “profile”, “shape”, and “dimension” of the prisms 14 and 24 means that such “profile”, “shape”, or “dimension” is the same within normal manufacturing tolerances. Interchangeability of the prisms 14 and 24 can allow for easier manufacturing.

As shown in FIGS. 3-6, the cube PBS 30 and 45 can have at least seven sides. For example, see sides 1-7 on cube PBS 30 in FIG. 4. The cube PBS 30 and 45 can have the number of sides and overall shape shown in FIGS. 3-6 to optimize the capture of divergent light into the cube PBS 30 and 45 while also keeping the cube PBS 30 and 45 reasonably small.

As shown in FIGS. 3-6, a profile (or shape) of the first prism 14 can be different than a profile (or shape) of the second prism 24. The first prism 14 can have different dimensions than the second prism 24. The first prism 14 can have a volume that is larger than a volume of the second prism 24. For example, the first prism 14 can have a volume that is at least 1.2 times larger, at least 1.1 times larger, or at least 1.3 times larger than a volume of the second prism 24. Some or all of these differences between the first prism 14 and the second prism 24 may be desirable for enlarging the usable entrance and exit faces of the prisms 14 and 24, while also keeping the overall cube PBS 30 and 45 as small as possible.

As shown in FIG. 5, a cube PBS 45, according to an embodiment described above, can be used in combination with, or as part of, an image projector 40. The image projector 40 can comprise a light source 42 located to emit a beam of light 46 into the first side 13 of the first prism 14. An optical axis of the beam of light 46 can be within +/−5 degrees of perpendicular to the first side 13 of the first prism 14. The cube PBS 45 can separate the beam of light 46 into a pair of polarized beams, including a desired beam 47 (e.g. s-polarized light) and an additional beam (e.g. p-polarized light, not shown). The desired beam 47 can reflect off of the polarizer 18 and can emit out of the cube PBS 45. The desired beam 47 can have a higher light intensity than the additional beam.

The desired beam 47 can emit out of the cube PBS 45 through the second side 12 of the first prism 14 with an optical axis of the desired beam 47 that is substantially perpendicular to the second side 12 of the first prism 14. For example, an optical axis of the desired beam 47 can be within +/−5 degrees of perpendicular to the second side 12 of the first prism 14.

A spatial light modulator 41 can be located to receive the desired beam 47 from the cube PBS 45. Examples of spatial light modulators 41 include liquid crystal display (LCD) and liquid crystal on silicon (LCoS). The spatial light modulator 41 can have a plurality of pixels, each pixel capable of receiving a signal and transmitting or reflecting a portion of the desired beam 47 without causing a change in polarization, or rotating a polarization of a portion of the desired beam 47, based on the signal, thus creating an image beam 48 of selectively polarized light.

The spatial light modulator 41 can emit the image beam 48 through the cube PBS 45 and out of the second side 22 of the second prism 24, which can be opposite of the second side 12 of the first prism 14. The image beam 48 can emit out of the second side 22 of the second prism 24 with an optical axis of the image beam 48 that is substantially perpendicular to the second side 22, such as for example within +/−5 degrees of perpendicular to the second side 22 of the second prism 24.

The spatial light modulator 41 and a projection lens system 43 can be oriented for the spatial light modulator 41 to emit the image beam 48 through the cube PBS 45 into the projection lens system 43. A portion of the image beam 48 that has had a polarization change in the spatial light modulator 41 can transmit through the cube PBS 45. The projection lens system 43 can project an image onto a screen 44 or directly into a person's eye.

As shown in FIG. 6, a cube PBS 45, according to an embodiment described above, can be used in combination with, or as part of, an image projector 50. The image projector 50 can comprise a light source 42 located to emit a beam of light 46 into the second side 22 of the second prism 14. An optical axis of the beam of light 46 can be within +/−5 degrees of perpendicular to the second side 22 of the second prism 14. The cube PBS 45 can separate the beam of light 46 into a pair of polarized beams, including a desired beam 57 (e.g. p-polarized light) and an additional beam (e.g. s-polarized light, not shown). The desired beam 57 can transmit through the polarizer 18, and can emit out of the cube PBS 45. The desired beam 57 can have a higher light intensity than the additional beam.

The desired beam 57 can emit out of the cube PBS 45 through the second side 12 of the first prism 14 with an optical axis of the desired beam 57 that is substantially perpendicular to the second side 12 of the first prism 14. For example, an optical axis of the desired beam 57 can be within +/−5 degrees of perpendicular to the second side 12 of the first prism 14.

A spatial light modulator 41 can be located to receive the desired beam 57 from the cube PBS 45. The spatial light modulator 41 can have a plurality of pixels, each pixel capable of receiving a signal and transmitting or reflecting a portion of the desired beam 57 without causing a change in polarization, or rotating a polarization of a portion of the desired beam 57, based on the signal, thus creating an image beam 58 of selectively polarized light.

The spatial light modulator 41 can be located to emit the image beam 58 to the polarizer 18 where it can reflect off of the polarizer 18 and emit out of the cube PBS 45 through the first side 13 of the first prism 14. A portion of the image beam 58 that has had a polarization change in the spatial light modulator 41 can reflect off of the polarizer 18. The image beam 58 can emit out of the first side 13 of the first prism 14 with an optical axis of the image beam 58 that is substantially perpendicular to the first side 13, such as for example within +/−5 degrees of perpendicular to the first side 13 of the first prism 14.

The spatial light modulator 41, the cube PBS 45, and a projection lens system 43 can be oriented for the spatial light modulator 41 to emit the image beam 58 through the first side 13 of the first prism 14 and into the projection lens system 43. The projection lens system 43 can project an image onto a screen 44 or directly into a person's eye.

What is claimed is:

1. A cube, polarizing beam-splitter (PBS) comprising:
a) a first prism including two ends linked by an inner face, a first side, and a second side;
b) a second prism including two ends linked by an inner face, a first side, and a second side;
c) a polarizer sandwiched between the inner face of the first prism and the inner face of the second prism; and
d) a first angle, between a plane of the first side of the first prism and a plane of the inner face of the first prism, having a value of between 10 degrees and 42.5 degrees;
e) a second angle, between a plane of the second side of the first prism and a plane of the inner face of the first prism, having a value of between 10 degrees and 42.5 degrees; and
f) |Eff₋₁₆−Eff₊₁₆|<0.25 across a wavelength range of 400 through 700 nanometers, where:
i) Eff₋₁₆ is an efficiency of the cube PBS with an angle of incidence on the polarizer equal to the first angle minus 16 degrees;
ii) Eff₊16 is an efficiency of the cube PBS with an angle of incidence on the polarizer equal to the first angle plus 16 degrees; and
iii) efficiency means a fraction transmission of a predominantly-transmitted polarization times a fraction reflectance of an opposite polarization.

2. The cube PBS of claim 1, wherein a difference between the first angle and the second angle is less than three degrees.

3. The cube PBS of claim 1, further comprising a third angle, between a plane of the first side of the first prism and a plane of the second side of the first prism, and wherein: |180-2*first angle−third angle|<5 degrees.

4. A cube, polarizing beam-splitter (PBS) comprising:
a) a first prism including two ends linked by an inner face, a first side, and a second side;
b) a second prism including two ends linked by an inner face, a first side, and a second side;
c) a polarizer sandwiched between the inner face of the first prism and the inner face of the second prism; and
d) a first angle, between a plane of the first side of the first prism and a plane of the inner face of the first prism, having a value of between 10 degrees and 42.5 degrees.

5. The cube PBS of claim 4, wherein a profile of the first prism is different than a profile of the second prism and the first prism has a volume that is at least 1.2 times larger than a volume of the second prism.

6. A cube, polarizing beam-splitter (PBS) comprising:
a) a first prism including two ends linked by an inner face, a first side, and a second side;
b) a second prism including two ends linked by an inner face, a first side, and a second side;
c) a polarizer sandwiched between the inner face of the first prism and the inner face of the second prism; and
d) a first angle, between a plane of the first side of the first prism and a plane of the inner face of the first prism, having a value of between 20 degrees and 40 degrees.

7. The cube PBS of claim 6, wherein the first angle is between 25 degrees and 35 degrees.

8. The cube PBS of claim 6, further comprising a second angle, between a plane of the second side of the first prism and a plane of the inner face of the first prism, having a value of between 20 degrees and 40 degrees.

9. The cube PBS of claim 8, wherein a difference between the first angle and the second angle is less than three degrees.

10. The cube PBS of claim 6, further comprising a third angle, between a plane of the first side of the first prism and a plane of the second side of the first prism, and wherein: |180-2*first angle−third angle|<5 degrees.

11. The cube PBS of claim 6, wherein |perpendicular-line−bisecting-line|<5 degrees, where:
a) the perpendicular-line is a line perpendicular to a face of the polarizer;
b) the bisecting-line is a line that bisects an angle between a plane of the first side of the first prism and a plane of the second side of the first prism.

12. The cube PBS of claim 6, wherein a profile of the first prism is the same as a profile of the second prism.

13. The cube PBS of claim 6, wherein a profile of the first prism is different than a profile of the second prism.

14. The cube PBS of claim 6, wherein the first prism has a volume that is at least 1.2 times larger than a volume of the second prism.

15. The cube PBS of claim 6, wherein a 435 nanometer wavelength incident light beam, with a 90° angle of incidence on the first side of the first prism, an angle of incidence on the polarizer equal to the first angle, and an angular-width equal to the angle of incidence +/−16°, has a efficiency of at least 55% across the angular-width of the light beam, where efficiency means a fraction transmission of a predominantly-transmitted polarization times a fraction reflectance of an opposite polarization.

16. The cube PBS of claim 6, wherein light across wavelength range of 400 through 700 nanometers, with a 45° angle of incidence on the first side, satisfies the equation |Eff₋₁₆−Eff₊₁₆|<0.25 where:
a) Eff₋₁₆ is an efficiency of the cube PBS with an angle of incidence on the polarizer equal to the first angle minus 16 degrees;
b) Eff₊₁₆ is an efficiency of the cube PBS with an angle of incidence on the polarizer equal to the first angle plus 16 degrees; and
c) efficiency means a fraction transmission of a predominantly-transmitted polarization times a fraction reflectance of an opposite polarization.

17. The cube PBS of claim 6, in combination with an image projector, the image projector comprising:
a) a light source located to emit a beam of light into the first side of the first prism, an optical axis of the beam of light is within +/−5 degrees of perpendicular to the first side of the first prism, the cube PBS separating the beam of light into a pair of polarized beams, including a desired beam and an additional beam, the desired beam having a higher light intensity than the additional beam, and emitting the desired beam out of the cube PBS;
b) a spatial light modulator:
i) located to receive the desired beam from the cube PBS; and
ii) having a plurality of pixels, each pixel capable of receiving a signal and transmitting or reflecting a portion of the desired beam without causing a change in polarization, or rotating a polarization of a portion of the desired beam, based on the signal, creating an image beam of selectively polarized light.

18. The combination of claim 17, wherein the desired beam is emitted out of the cube PBS through the second side of the first prism with an optical axis of the desired beam that is within +/−5 degrees of perpendicular to the second side of the first prism.

19. The combination of claim 17, further comprising a projection lens system, wherein:
a) the spatial light modulator and the projection lens system are oriented for the spatial light modulator to emit the image beam through the cube PBS into the projection lens system;
b) the second side of the second prism is opposite of the second side of the first prism and the image beam is emitted out of the cube PBS through the second side of the second prism with an optical axis of the image beam that is within +/−5 degrees of perpendicular to the second side of the second prism; and
c) the projection lens system is capable of projecting an image.

20. The cube PBS of claim 6, wherein the cube PBS has at least seven sides.
